(19) United States
(12) Patent Application Publication
(10) Pub. No.: US 2003/0224227 A1
(43) Pub. Date: Dec. 4, 2003

(54) Conditioning and maintenance methods for fuel cells

(75) Inventors: Henry H. Voss, West Vancouver (CA); Russell H. Barton, New Westminster (CA); Michael Sexsmith, North Vancouver (CA); Mark J. Turchyn, Cloverdale (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Inc., Burnaby, BC (CA)

(21) Appl. No.: 10/159,594

(22) Filed: May 30, 2002

(51) Int. Cl. H01M 8/04; H01M 4/92; H01M 8/10

(52) U.S. Cl. 429/13; 429/40; 429/30; 429/22

(57) ABSTRACT

Certain fuel cells (e.g., solid polymer electrolyte fuel cells) may temporarily exhibit below normal performance after initial manufacture or after prolonged storage. While normal performance levels may be obtained after operating such fuel cells for a suitable time period, this process can take of order of days to fully complete. However, various conditioning and/or maintenance techniques are disclosed that provide for normal performance levels without the need for a lengthy initial operating period.

### BACKGROUND OF THE INVENTION

1. Field of the Invention

The invention relates to methods for conditioning and maintenance of fuel cells such that they are capable of performing normally after initial manufacture or after prolonged storage. In particular, it relates to methods for conditioning and maintenance of solid polymer fuel cells.

2. Description of the Related Art

Fuel cell systems are increasingly being used as power supplies in various applications, such as stationary power plants and portable power units. Such systems offer promise of economically delivering power while providing environmental benefits.

Fuel cells convert fuel and oxidant reactants to generate electric power and reaction products. They generally employ an electrolyte disposed between cathode and anode electrodes. A catalyst typically induces the desired electrochemical reactions at the electrodes. Preferred fuel cell types include solid polymer electrolyte (SPE) fuel cells that comprise a solid polymer electrolyte and operate at relatively low temperatures. Another fuel cell type that operates at a relatively low temperature is the phosphoric acid fuel cell.

SPE fuel cells employ a membrane electrode assembly (MEA) that comprises the solid polymer electrolyte or ion-exchange membrane disposed between the cathode and anode. (Typically, the electrolyte is bonded under heat and pressure to the electrodes and thus such an MEA is dry as assembled.) Each electrode contains a catalyst layer, comprising an appropriate catalyst, located next to the solid polymer electrolyte. The catalyst is typically a precious metal composition (e.g., platinum metal black or an alloy thereof) and may be provided on a suitable support (e.g., fine platinum particles supported on a carbon black support). The catalyst layers may contain ionomer similar to that used for the solid polymer membrane electrolyte (e.g., Nafion®). The electrodes may also contain a porous, electrically conductive substrate that may be employed for purposes of mechanical support, electrical conduction, and/or reactant distribution, thus serving as a fluid diffusion layer. Flow field plates for directing the reactants across one surface of each electrode or electrode substrate, are disposed on each side of the MEA. In operation, the output voltage of an individual fuel cell under load is generally below one volt. Therefore, in order to provide greater output voltage, numerous cells are usually stacked together and are electrically connected in series to create a higher voltage fuel cell stack.

During normal operation of a SPE fuel cell, fuel is electrochemically oxidized at the anode catalyst, typically resulting in the generation of protons, electrons, and possibly other species depending on the fuel employed. The protons are conducted from the reaction sites at which they are generated, through the electrolyte, to electrochemically react with the oxidant at the cathode catalyst. The electrons travel through an external circuit providing useable power and then react with the protons and oxidant at the cathode catalyst to generate water reaction product.

A broad range of reactants can be used in SPE fuel cells and may be supplied in either gaseous or liquid form. For example, the oxidant stream may be substantially pure oxygen gas or a dilute oxygen stream such as air. The fuel may be, for example, substantially pure hydrogen gas, a gaseous hydrogen-containing reformate stream, or an aqueous liquid methanol mixture in a direct methanol fuel cell.

During manufacture of SPE fuel cells, it is common to employ a conditioning or activating step in order to hydrate the membrane and also any ionomer present in the catalyst layers (e.g., as disclosed in Canadian patent application serial number 2,341,140). However, the fuel cells may also be “run in”, that is operated for a period of time under controlled low load conditions in a manner akin to a breaking in period, after which the nominal rated performance of the fuel cell is obtained. Such a breaking in process however may be onerous in large-scale manufacture since connecting up and operating each stack represents a relatively complex, time-consuming, and expensive procedure.

For various reasons, fuel cell performance can fade with operation time or during storage. However, some of this performance loss may be reversible. For instance, the negative effect of the membrane electrolyte and/or other ionomer drying out during storage can be reversed by rehydrating the fuel cell. Also, the negative effects of CO contamination of an anode catalyst can be reversed using electrical and/or fuel starvation techniques. Published PCT patent applications WO99/34465, WO01/01508, and WO01/03215 disclose some of the other various advantages and/or performance improvements that can be obtained using appropriate starvation techniques in fuel cells.

While some of the mechanisms affecting performance in fuel cells are understood and means have been developed to mitigate them, other mechanisms affecting performance are not yet fully understood and unexpected effects on performance are just being discovered.

### BRIEF SUMMARY OF THE INVENTION

In certain circumstances, a fuel cell may be performing below normal levels, but with prolonged operation, the performance may slowly increase to normal. In such circumstances, it has been discovered that performance can be improved by drawing power from the fuel cell briefly in the absence of oxidant. For instance, this method may be used to activate a fuel cell after initial manufacture, thereby obviating a lengthy activation process. Alternatively, this method may be used to rejuvenate a fuel cell following prolonged storage.

The conditioning method is used prior to normal operation. Herein, normal operation is defined as supplying a fuel stream to the anode of the fuel cell, supplying an oxidant stream to the cathode of the fuel cell, and supplying power from the fuel cell to an external electrical load. The conditioning method then comprises supplying the fuel reactant stream to the fuel cell anode without supplying the oxidant stream to the cathode, and applying a conditioning load to the fuel cell. Thus, the fuel cell is not fuel starved using the present method. Power is drawn by the conditioning load and thus conditioning may be accomplished without supplying power from the fuel cell to the external electrical load.

The method is suitable for use with fuel cells whose cathode comprises a precious metal catalyst (e.g., platinum) and is particularly suitable for use with typical solid polymer electrolyte fuel cells.

During the conditioning, the voltage of the fuel cell remains greater than or equal to zero. Performance improvements may be obtained even when the voltage of the fuel cell remains greater than 0.4 V during the conditioning.

By drawing current from a fuel cell in the absence of oxidant, reducing conditions are produced at the cathode due to the higher concentration of hydrogen and lower concentration of oxidant. Oxidized species can thus be reduced. This helps to condition the fuel cell.

The method is particularly advantageous for manufacturing purposes and for commercial applications where the fuel cell stack spends prolonged periods inactive and yet desirably delivers normal output power in a timely manner once put into service.

In this regard, it may be desirable that the commercial fuel cell system is capable of automatically conditioning itself (i.e., self-conditioning).

A possible embodiment of a self-conditioning system comprises a fuel cell, a fuel supply system, an oxidant supply system, an internal conditioning load, and a controller. In this embodiment, the fuel cell comprises an anode, a cathode, and an electrolyte. The fuel supply system comprises a fuel supply, a fuel supply line fluidly connecting the fuel supply to the anode, and fuel valving for controlling the flow of fuel to the anode. The oxidant supply system comprises an oxidant supply, an oxidant supply line fluidly connecting the oxidant supply to the cathode, and oxidant valving for controlling the flow of oxidant to the cathode. The internal conditioning load is electrically connectable to the terminals of the fuel cell and is connected and disconnected in accordance with signals from the controller. Finally, the controller is used to control the fuel and oxidant valving and the internal conditioning load such that such that fuel is supplied to the anode, oxidant is supplied to the cathode, and the internal conditioning load is disconnected from the fuel cell terminals during normal operation, and yet such that fuel is supplied to the anode, oxidant is not supplied to the cathode, and the internal conditioning load is connected to the fuel cell terminals during conditioning. Preferably, for system simplicity, an ancillary component in the fuel cell system (e.g., a cooling fan) is used as the internal conditioning load.

Instead of or in addition to conditioning a fuel cell following a storage period, it may be advantageous to take steps to prevent a temporary loss in performance from occurring in the first place. It is believed that the preceding methods and systems improve fuel cell performance by reducing the cathode catalyst and removing any oxides and/or hydroxides formed thereon. Thus, methods that prevent the formation of oxides and/or hydroxides on the cathode catalyst may be useful in preventing a performance loss. Such methods include applying a potential to the fuel cell during the storage period (e.g., from 0 to 0.6 V/cell), storing the fuel cell at a temperature below ambient (e.g., below about −20° C.) during the storage period, or storing the fuel cell with a blanket of inert gas on the cathode during the storage period.

In the manufacture of a fuel cell, conditioning using the preceding methods is typically performed after assembly is otherwise essentially complete. However, instead of or in addition to conditioning in this manner, it may be advantageous to reduce the cathode catalyst at some earlier stage of assembly. If the cathode catalyst is adequately reduced and maintained in a reduced state, subsequent conditioning may not be necessary. Therefore, a method of manufacturing a fuel cell that augments and/or substitutes for conditioning comprises reducing the cathode catalyst at some point during manufacture, and maintaining the reduced cathode catalyst in an inert atmosphere until manufacturing is complete. The reducing step can be accomplished by exposing the cathode catalyst to a fluid comprising a reducing agent (e.g., hydrogen gas). An atmosphere essentially free of oxygen and water is suitably inert in order to maintain the catalyst in a reduced state.

### BRIEF DESCRIPTION OF THE DRAWING

FIG. 1 is a schematic diagram of a solid polymer fuel cell system equipped to condition the fuel cell by connecting a conditioning load across the electrodes while supplying the anode with hydrogen.

### DETAILED DESCRIPTION OF THE INVENTION

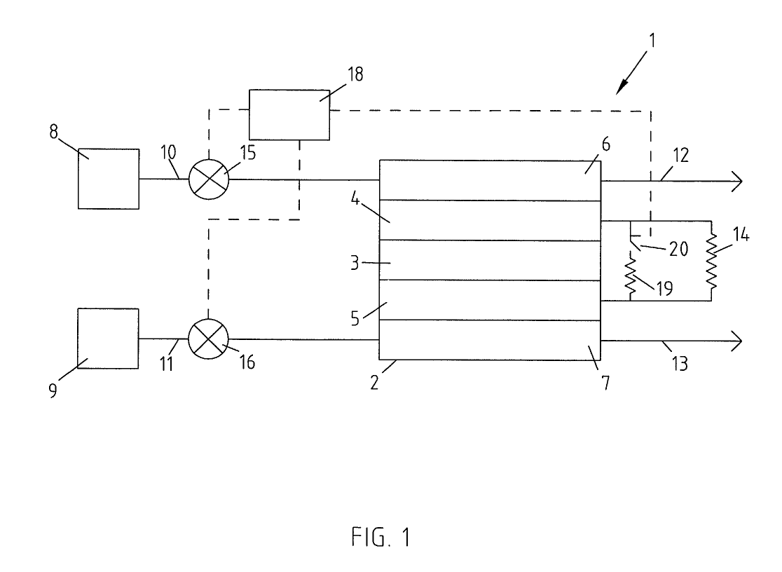

FIG. 1 shows a schematic diagram of a solid polymer fuel cell system in which the fuel cell may be conditioned in accordance with the invention. Conditioning may be performed either to rejuvenate the fuel cell after undergoing a temporary performance loss as a result of prolonged storage or to activate the fuel cell such that it is capable of nominal performance immediately after initial manufacture.

For simplicity, FIG. 1 shows only one cell in the fuel cell stack in system 1. Fuel cell stack 2 comprises a membrane electrode assembly consisting of solid polymer electrolyte membrane 3 sandwiched between cathode 4 and anode 5. (Both cathode 4 and anode 5 comprise porous substrates and catalyst layers which are not shown.) Stack 2 also comprises cathode flow field plate 6 and anode flow field plate 7 for distributing reactants to cathode 4 and anode 5 respectively. System 1 also has fuel and oxidant supply systems containing oxidant supply 8 (typically air, which may be supplied by a blower or compressor) and fuel supply 9 (considered here to be a source of hydrogen gas).

During normal operation, oxidant and fuel are supplied to flow field plates 6 and 7 respectively via oxidant and fuel supply lines 10 and 11 respectively. The oxidant and fuel streams exhaust from stack 2 via exhaust lines 12 and 13 respectively. Power from stack 2 is delivered to external electrical load 14, which is electrically connected across the terminals of stack 2.

In FIG. 1, system 1 is equipped to condition stack 2 by applying a conditioning load while the fuel but not the oxidant reactants are supplied to stack 2. This procedure can indirectly result in cathode 4 being supplied electrochemically with protons obtained from the anode side of the fuel cell. System 1 includes oxidant shutoff valve 15, fuel shutoff valve 16, controller 18, and an internal circuit comprising conditioning load 19 and switch 20. The operation of the valves 15 and 16 and operation of switch 20 are controlled by controller 18 via the various dashed signal lines depicted in FIG. 1. During normal operation, oxidant shutoff valve 15 and fuel shutoff valve 16 are open, while switch 20 is open. Thus, oxidant and hydrogen are supplied normally to cathode 4 and anode 5 respectively. When the system is inactive, valves 15 and 16 are closed and switch 20 is desirably open. For purposes of conditioning, controller 18 signals oxidant shutoff valve 15 and switch 20 to close and fuel shutoff valve 16 to open. Hydrogen is thus provided to anode 4 but no oxidant is provided to cathode 5. With conditioning load 19 now connected across the stack terminals, stack 2 is operating in an air starvation mode. Due to the chemical potential difference, an electric potential exists in stack 2 that results in current flow through conditioning load 19. In this air-starved mode, protons can be electrochemically pumped across electrolyte membrane 2 from anode 5 to cathode 4 (hydrogen being oxidized to protons at the former and protons reduced back to hydrogen at the latter). Thus, cathode 4 may be exposed to reducing conditions that help to rejuvenate stack 2. In general, the presence of external electrical load 14 during conditioning is optional. However, depending on the specific embodiment, it may be desirable to disconnect external load 14 (e.g., to protect it from power surges) or to keep it connected instead (to function in a like manner to internal conditioning load 19). [If disconnecting external load 14 is desired, an additional switch (not shown) that is also controlled by controller 18 could be incorporated in series with load 14.]

For greater effectiveness, conditioning load 19 is selected such that the stack voltage is kept quite low under load. However, benefits may still be obtained when the voltage of the fuel cells in the stack remains relatively high, e.g., about or greater than 0.4 V during conditioning. Initially, the stack voltage and hence current capability from stack 2 during conditioning may be relatively high but is expected to drop off quickly under load. Thus, it can be advantageous for conditioning load 19 to be variable to limit the maximum initial current draw while still allowing for a larger current draw at the end of the conditioning period. On the other hand, for system simplicity, it may be preferred overall to avoid including a separate additional component to serve as conditioning load 14. In such a case, an existing system component (e.g., blower or cooling fan) may serve as conditioning load 14 during the conditioning cycle.

System 1 is thus equipped to condition itself as is required in the field. Controller 18 may be programmed for instance to run the system through a conditioning cycle every time it is started up to ensure that the fuel cell is operating normally. In such a case, the starting sequence may then involve automatic configuring of valves 15, 16, and switch 20 so as to condition for a brief period (e.g., of order of a minute), followed by a configuring for normal operation. A possible additional advantage of this embodiment is that any electrochemical pumping of hydrogen generates heat that can accelerate the conditioning process.

The method of the invention can also be readily employed on conventional SPE fuel cell systems, in which case the operator initiates conditioning as desired. Here, a suitable external apparatus (e.g., a conditioning unit comprising a controller, conditioning load, and switch) would be appropriately connected to the system while control of the reactant supplies may be done manually. Thus, conventional fuel cells or systems can be activated in this way during manufacture at a conditioning station on an assembly line. Alternatively, conventional fuel cells or systems may be rejuvenated after prolonged storage in the field or at a service center using a suitable conditioning unit.

Using the aforementioned methods, SPE fuel cells that had been adversely affected by prolonged storage can be successfully rejuvenated relatively quickly. For instance, SPE fuel cell stacks operating at current densities about 400 mA/cm² may exhibit output voltage drops of order of 10-20 mV per cell after storing under ambient conditions for a month (the voltage drops being greater at higher ambient temperature conditions). When put back into normal service without any prior conditioning, such stacks can require over a day of operation before recovering completely. On the other hand, similar stacks show almost complete recovery immediately after a conditioning period of the order of a minute.

Without being bound by theory, it is believed that the lower than nominal performance capability seen in newly manufactured SPE fuel cells or in cells subjected to prolonged storage may be due to the formation of oxides or hydroxides on the surface of the cathode catalyst. Such species could be expected to form in the presence of oxygen and water or the presence of adsorbed contaminants and the rate would increase at elevated temperatures. Reducing the cathode catalyst then, such as with suitable exposure to reducing conditions or by operating the cell for a sufficiently long period, would then be expected to react these species away. The reduction reaction would thus form water and leave behind catalyst whose surface was free of oxide/hydroxide thereby activating or rejuvenating the catalyst and also, to some extent, rehydrating the fuel cell. (Noticing an adverse effect on performance with the formation of oxides and/or hydroxides on a platinum cathode catalyst surface would be consistent with the observations of M. Pourbaix “Atlas of Electrochemical Equilibria in Aqueous Solutions”, 1966, Pergamon Press, N.Y. and A. J. Appleby and A. Borucka, J. Electrochem. Soc. 116, 1212 (1969), who reported that oxygen reduction rates are higher for platinum than for platinum hydroxide or for oxidized platinum respectively.) The reducing conditions could also affect adsorbed contaminants either by causing them to desorb or by causing them to react into less harmful species.

Accordingly, other methods to assist in the removal of surface oxides/hydroxides from the cathode catalyst or to prevent their formation are also desirably contemplated. For instance, in the embodiment of FIG. 1, external power may be applied at times to assist in the electrochemical pumping of hydrogen across the membrane electrolyte. Also, for instance, the fuel cell might be maintained in a conditioned state in various ways in order to prevent temporary losses in performance capability. As an example, oxide and hydroxide formation might be prevented by maintaining the cathode at a suitable potential (by applying an external power source to the fuel cell). Alternatively, storing the fuel cell at below ambient temperature would slow the rate of formation of oxides or hydroxides. Blanketing the cathode with an inert gas such as dry nitrogen during storage would also be expected to slow the formation of oxide/hydroxide species. In this regard, inert refers to a gas composition that doesn't poison or react with the cathode catalyst. Certain reducing atmospheres, such as hydrogen gas, could be inert to the catalyst but not to undesirable oxides or hydroxides. Thus, maintaining a reducing atmosphere around the cathode (by directly admitting hydrogen, by allowing hydrogen from the anode to diffuse across the membrane electrolyte to the cathode, or by substantially decreasing oxidant concentration) might be preferred.

If the fuel cell can be maintained in a suitably conditioned state, one may consider performing conditioning cycles well before the fuel cell actually needs to be used. For instance, in the embodiments of FIG. 1, one may also consider running conditioning cycles partway through a storage period or even at shutdown.

In the manufacture of a fuel cell, similar techniques may be employed to effectively condition the cell during assembly. For instance, conditioning may effectively be accomplished by reducing the cathode catalyst at some point during assembly (e.g., reducing the catalyst by itself, or after making the cathode, or after making the MEA, etc.) and then preventing the formation of oxides and hydroxides by maintaining the cathode catalyst in an inert atmosphere thereafter.

The following examples are provided to illustrate certain aspects and embodiments of the invention but should not be construed as limiting in any way.

### EXAMPLE 1

A solid polymer fuel cell stack comprising 47 cells stacked in series was assembled and fully conditioned by operating it under load until its full normal performance capability was reached. Each cell in the stack contained a 115 cm² active area membrane electrode assembly with platinum catalyzed electrodes and a NAFION® N112 perfluorosulfonic acid membrane electrolyte. On both cathode and anode, carbon-supported Pt catalyst was employed on carbon fiber substrates. The stack employed serpentine flow field plates made of graphite clamped between end plates at a loading of 1200 lbs. Typical normal operation for this stack involves supplying hydrogen and air, at about 5 and 3 psi, respectively, to the cathode and anode flow field plates, respectively. The normal operating temperature of the stack is 65° C. The maximum normal operating current density is about 0.5 A/cm². Under a 44 A load, the voltage of the fully conditioned stack was about 28.8 V (corresponding to an average cell voltage of about 610 mV).

The stack was then put in storage for 141 days. After this storage period, the stack was then started up under normal operating conditions at 44 A load. The stack voltage was now only about 26.6 V, indicative of a significant loss in performance. The stack was then rejuvenated by subjecting it to several conditioning cycles. Each cycle involved shutting off the supply of air, while still supplying hydrogen to the anode, and connecting the stack across a 8 ohm resistor until the stack voltage dropped below two volts. The supply of air was then restored and the stack voltage recovered. Each cycle took about one minute to complete and the stack was subjected to five consecutive conditioning cycles. Immediately thereafter, the stack was operated under normal operating conditions at 48 A load (slightly higher than initially). The stack voltage after rejuvenating was now about 27.8 V, a significant improvement especially since tested at a slightly higher current.

### EXAMPLE 2

A fuel cell stack similar to that of Example 1 was assembled and fully conditioned by operating it under load until its full normal performance capability was reached. The stack voltage was determined to be about 29 V (i.e., average cell voltage of about 620 mV) when operating the stack normally under a 45 A load. The stack was then shutdown and stored for approximately 6 months. After the storage period, the stack was restarted without undergoing a conditioning procedure and was operated normally for about 10 minutes. The stack voltage was about 26.4 V. The stack was then shutdown and was subjected to five conditioning cycles. In each cycle, hydrogen was continually supplied to the anode. In each cycle, air was initially supplied to the cathode for a few seconds and then the air supply was closed off. A load was then applied to the stack voltage dropped to about 20 V at which point the cycle was complete. The stack was then operated normally for about 10 minutes and the stack voltage was now 27.2 V.

Thus, a significant performance recovery was achieved even when the stack voltage remained above about 20 V during conditioning (greater than about 0.4 V per cell).

### EXAMPLE 3

Several solid polymer fuel cell stacks similar to those in Example 2 were assembled and fully conditioned by operating under load until full normal performance capability was reached. The stacks were then shut down by removing the load, reducing the fuel and oxidant reactant pressures, and closing the reactant inlets and outlets. The stacks were then stored at various different temperatures, namely −20° C., ambient (actually varying between 20 and 30° C.), and 70° C. The stacks were performance tested weekly by operating them under load for 3 hours at a time. Note that, to some extent, this weekly operation would itself be expected to condition the stacks and improve stack performance somewhat.

From the weekly testing, it was observed that the two stacks stored at −20° C. showed little to no voltage loss over 7 months of storage and testing. The two cells stored at ambient showed stack voltage losses between about 0.1 and 0.33 V/month over 11 months of storage and testing. The several cells stored at 70° C. showed stack voltage losses of about 1.2 V/month over the first three months and then leveled off at a total stack voltage loss of about 4 volts thereafter over the total eight months of testing and storage. It was noticed that approximately ⅔ of the stack voltage loss was recovered over the three hours of testing (i.e., a significant but incomplete conditioning of the stack occurs over three hours of operation).

This example shows the temperature dependence of the performance (voltage) loss during storage and that the loss can be avoided by storing the fuel cell stack at suitably low temperatures.

While particular elements, embodiments and applications of the present invention have been shown and described, it will be understood, of course, that the invention is not limited thereto, except as by the appended claims, since modifications may be made by those skilled in the art without departing from the spirit and scope of the present disclosure, particularly in light of the foregoing teachings.

All of the above U.S. patents, U.S. patent application publications, U.S. patent applications, foreign patents, foreign patent applications and non-patent publications referred to in this specification and/or listed in the Application Data Sheet are incorporated herein by reference, in their entirety.

What is claimed is:

1. A method for conditioning a fuel cell for normal operation, the fuel cell comprising a cathode, an anode, and an electrolyte, and normal operation comprising supplying fuel to the anode, supplying oxidant to the cathode, and supplying power from the fuel cell to an external electrical load, wherein the method comprises:
supplying the fuel reactant stream to the fuel cell anode without supplying the oxidant stream to the cathode; and
applying a conditioning load to the fuel cell.

2. The method of claim 1 wherein the method comprises applying the conditioning load to the fuel cell without supplying power from the fuel cell to the external electrical load.

3. The method of claim 1 wherein the cathode comprises a precious metal catalyst.

4. The method of claim 3 wherein the cathode catalyst comprises platinum.

5. The method of claim 1 wherein the fuel cell is a solid polymer electrolyte fuel cell.

6. The method of claim 1 wherein the voltage of the fuel cell remains greater than or equal to zero during the conditioning.

7. The method of claim 6 wherein the voltage of the fuel cell remains greater than 0.4 V during the conditioning.

8. The method of claim 6 wherein protons derived from the fuel are electrochemically pumped across the electrolyte from the anode to the cathode.

9. The method of claim 1 wherein the conditioning is performed after manufacturing the fuel cell.

10. The method of claim 1 wherein the conditioning is performed after the fuel cell has been operated normally and then stored for a period of time.

11. A fuel cell system capable of normal operation and of self-conditioning comprising:
a fuel cell comprising an anode, a cathode, and an electrolyte;
a fuel supply system comprising a fuel supply, a fuel supply line fluidly connecting the fuel supply to the anode, and fuel valving for controlling the flow of fuel to the anode;
an oxidant supply system comprising an oxidant supply, an oxidant supply line fluidly connecting the oxidant supply to the cathode, and oxidant valving for controlling the flow of oxidant to the cathode;
an internal conditioning load electrically connectable to the terminals of the fuel cell; and
a controller for controlling the fuel valving, the oxidant valving, and the internal conditioning load such that fuel is supplied to the anode, oxidant is supplied to the cathode, and the internal conditioning load is disconnected from the fuel cell terminals during normal operation, and such that fuel is supplied to the anode, oxidant is not supplied to the cathode, and the internal conditioning load is connected to the fuel cell terminals during conditioning.

12. The fuel cell system of claim 11 wherein the internal conditioning load is an ancillary component of the fuel cell system.

13. A method of maintaining a fuel cell over a storage period to prevent a temporary loss in performance, wherein the method comprises applying a potential to the fuel cell during the storage period.

14. A method of maintaining a fuel cell over a storage period to prevent a temporary loss in performance, wherein the method comprises storing the fuel cell at a temperature below ambient during the storage period.

15. The method of claim 14 wherein the fuel cell is stored at a temperature below about −20° C.

16. A method of manufacturing a fuel cell comprising an anode, an electrolyte, and a cathode comprising a cathode catalyst, wherein the method comprises:
reducing the cathode catalyst; and
maintaining the reduced cathode catalyst in an inert atmosphere until manufacturing is complete.

17. The method of claim 16 wherein the inert atmosphere is essentially free of oxygen.

18. The method of claim 16 wherein the inert atmosphere is essentially free of water.

19. The method of claim 16 wherein the reducing step comprises exposing the cathode catalyst to a fluid comprising a reducing agent.
